(19) United States
(12) Patent Application Publication
(10) Pub. No.: US 2005/0184244 A1
(43) Pub. Date: Aug. 25, 2005

(54) Radiation detector and light or radiation detector

(75) Inventors: Toshinori Yoshimuta, Takatuki-shi (JP); Shinya Hirasawa, Uji-shi (JP)

Correspondence Address: RANKIN, HILL, PORTER & CLARK LLP, 4080 ERIE STREET, WILLOUGHBY, OH, 44094-7836, US

(73) Assignee: SHIMADZU CORPORATION, Kyoto-shi (JP)

(21) Appl. No.: 11/061,192

(22) Filed: Feb. 18, 2005

(30) Foreign Application Priority Data
Feb. 25, 2004 (JP) 2004-049328
Mar. 16, 2004 (JP) 2004-074233

(51) Int. Cl. G01T 1/24

(52) U.S. Cl. 250/370.01

(57) ABSTRACT

A shielding plate is made of a conductive material connected to a ground. The shielding plate is arranged between a photo timer for measuring an amount of the radiation and a radiation-sensitive semiconductor thick film over an entire surface of an effective area for X-ray detection. The shielding plate shields a radiation noise from the photo timer, and thus the radiation noise can be released by connecting the shielding plate to the ground. As a result, the radiation noise from the photo timer which has influence on the radiation detector can be reduced.

This application claims foreign priorities based on Japanese patent application JP2004-049328, filed on Feb. 25, 2004 and Japanese patent application JP2004-074233, filed on Mar. 16, 2004, the contents of which are incorporated herein by reference in its entirety.

### BACKGROUND OF THE INVENTION

1. Field of the Invention

The present invention relates to a radiation detector and a light or radiation detector, which are used in medical field, industrial field, atomic energy field or the like.

2. Description of the Related Art

A related-art X-ray detection device includes an X ray-sensitive X-ray conversion layer (semiconductor layer) which converts X-ray information into electric charge information for an X-ray incident thereon. The X-ray detection device detects the X-ray by reading the converted electric charge information from the X-ray conversion layer. A photo timer (radiation amount measuring member) for measuring the X-ray amount is arranged at a side of the X-ray conversion layer on which the X ray is incident. Here, the photo timer is used to control the output of the X-ray according to the X-ray amount measured by the photo timer. Further, as shown in FIG. 7, a shielding plate (shielding member) 103 for shielding light or the like is arranged between the X-ray conversion layer 101 and the photo timer 102 (a voltage application electrode or the like is not shown in the drawing). In order to maximally reduce the attenuation of the X ray caused by the shielding plate, the shielding plate 103 is made of a material having a low shielding rate, such as carbon or a resin. In addition, there is an X-ray detection device in which the photo timer is arranged on an area (for example, a corner) other than the effective area for X ray detection (the effective area for radiation detection) (for example, see Japanese Patent Laid-Open No. 2002-90461 (pages 2 to 4, FIGS. 1 to 3)).

However, since the electric charge converted from the X-ray by the X-ray conversion layer is extremely weak, the electric charge is needed to be amplified. At that time, the noise also is amplified, and thus, in order to obtain an image having an excellent S/N ratio (signal-to-noise ratio), the low noise is demanded. On the other hand, as for the photo timer, the low noise is not demanded. Thus, as a power supply for driving the photo timer, a power supply having a high noise is generally used, and a general switching power supply is used to achieve a small-size and low-cost detection device.

Further, a related-art two-dimensional radiation detector will be described with reference to FIG. 8. FIG. 8 is a schematic cross-sectional view of a related-art two-dimensional radiation detector. The two-dimensional radiation detector includes a radiation-sensitive radiation conversion layer (semiconductor layer) 1. When a radiation is incident on the radiation detector in a state in which a voltage is applied to a voltage application electrode 3 deposited on the radiation conversion layer 1, the radiation is converted into electric charge information at the radiation conversion layer 1, and then the electric charge information is read by an active matrix substrate 5. Since the read electric charge information is weak, the read electric charge information is amplified by an amplifier (not shown), so that the radiation can be detected. A radiation detection signal obtained in such a manner is used for generating a fluoroscopic image.

Here, the electric charge information is generated by the radiation. However, through the discharge of the voltage application electrode 3, the radiation conversion layer 1 detects the movement of the electric charge, so that the same electric charge information is generated. The unexpected electric charge information overlaps the electric charge information generated by the radiation as a noise component. As described above, since the electric charge information converted from the radiation is weak, it is seriously affected by the noise component, which results in decreasing the definition of the fluoroscopic image or the like obtained from the electric charge information. Thus, the voltage application electrode 3 is typically sealed by an insulating film 7 so as not to be discharged. Further, in order to remove the noise component, a dummy pixel for reading only the noise component is generally used (for example, see Japanese Patent Laid-Open No. 2003-46075).

The related-art two-dimensional radiation detector having the above-mentioned configuration has the following problems.

Specifically, in the related-art two-dimensional radiation detector, when a voltage is applied thereto, static electricity is generated on a surface 7S of the insulating film 7 sealing the voltage application electrode 3 on which the radiation is incident. For example, when the radiation is discharged to a case (not shown) of the two-dimensional radiation detector, the noise component is generated.

For this reason, the discharge of the static electricity is prevented such that the electric potential difference between the surface 7S of the insulating film 7 and the vicinity thereof, that is, the case of the two-dimensional radiation detector is maintained small. In FIG. 8, a conductive plate 31 is deposited on a peripheral portion of the insulating film 7 that is separated from an effective area capable of detecting the radiation and is connected to a ground electrode. In addition, a method that the vicinity of a driving unit (not shown) for driving an active matrix substrate 5 or an amplifying unit for amplifying the read electric charge information is connected to the ground is adopted.

However, the above-mentioned methods fall short of preventing the static electricity from electrifying. The static electricity electrified on the surface 7S of the insulating film 7 attracts dust particles from a periphery to cause the generation of a new discharge, that is, a new noise component. Therefore, the new noise component overlaps the electric charge information generated by the radiation.

### SUMMARY OF THE INVENTION

The present invention has been made in consideration of the above-mentioned problems.

It is a first object of the present invention to provide a radiation detector which can reduce a noise.

It is a second object of the present invention to provide a light or radiation detector which can reduce the influence of static electricity.

Inventors of the present invention have obtained the following results after an extensive research.

Specifically, it is assumed that the noise caused by the photo timer has influence on the X-ray detection device. Therefore, it is considered that the photo timer is arranged on an area other than the effective area for X-ray detection as in the above-mentioned related-art. However, this does not result in achieving a low noise. Further, it is also considered that the shielding plate is arranged between the X-ray conversion layer and the photo timer over the area only on which the photo timer is arranged so as to shield the noise. However, this also does not result in achieving a low noise. Therefore, it is considered that the noise is generated from a switching power supply or a driving circuit for driving the photo timer, or the wiring lines for connecting the driving circuit or the switching power supply to the photo timer, and the noise is spread as a radiation noise to have an adverse influence on the X-ray detection device.

The radiation detector includes a direct conversion type radiation detector which has a radiation-sensitive semiconductor layer serving as the X-ray conversion layer for directly converting a radiation into electric charge information, and an indirect conversion type radiation detector which has a scintillator or a light-sensitive semiconductor layer for converting the radiation into light which is subsequently converted into the electric charge information. In particular, when the radiation detector is the direct conversion type radiation detector, the semiconductor layer is made of amorphous selenium (a-Se). Since the radiation-sensitive semiconductor layer made of amorphous selenium is thicker than the light-sensitive semiconductor layer of the indirect conversion type radiation detector, the radiation-sensitive semiconductor layer needs a high bias voltage (for example, several hundreds of volts to several tens of thousands of volts). In the case of such a direct conversion type radiation detector, since the high bias voltage is applied thereto, it is particularly easy to be affected the influence of the radiation noise. Therefore, the inventors have obtained the knowledge that the shielding member serving as the shielding plate is made of a conductive material connected to a ground to shield the radiation noise and the shielding member is arranged over an entire surface of an effective area for radiation detection.

In order to achieve the above-mentioned first object, the present invention has the following configurations.

According to a first aspect of the present invention, there is provided radiation detector for detecting a radiation, comprising:
a semiconductor layer for converting radiation information into electric charge information for a radiation incident thereon;
a radiation amount measuring member for measuring an amount of the radiation, the radiation amount measuring member being arranged at a side onto which the radiation is incident; and
a shielding member for shielding light, the shielding member being arranged over an entire surface of an effective area for radiation detection between the radiation amount measuring member and the semiconductor layer,
wherein the shielding member is made of a conductive material connected to a ground.

According to the first aspect, the shielding member is made of the conductive material connected to the ground and the shielding member is arranged between the radiation amount measuring member and the semiconductor layer over the entire surface of the effective surface for radiation detection. Therefore, the shielding member shields a radiation noise from the radiation amount measuring member, and thus the radiation noise can be released by connecting the shielding member to the ground. As a result, the radiation noise from the radiation amount measuring member which has influence on the radiation detector can be reduced.

According to a second aspect of the present invention, the present invention can be applied to an indirect conversion type radiation detector which has a fluorescent body (scintillator) for converting radiation information into light and a light-sensitive semiconductor layer for indirectly converting the radiation information into the electric charge information, that is, converting light into the electric charge information. In addition, the present invention can be applied to a direct conversion type radiation detector which has a radiation-sensitive semiconductor layer for directly converting the radiation information into the electric charge information. In particular, since the radiation noise from the radiation amount measuring member is conspicuous in the related-art, the direct conversion type radiation detector is particularly useful for reducing the radiation noise.

In order to achieve the above-mentioned second object, the present invention has the following configurations.

According to a third aspect of the present invention, there is provided A light or radiation detector for detecting light or a radiation, comprising:
a semiconductor layer for converting light information or radiation information into electric charge information for light or the radiation incident thereon;
a voltage application electrode for applying a voltage to the semiconductor layer, the voltage application electrode being deposited at an incident side of the semiconductor layer onto which the light or radiation is incident;
an insulating layer for covering the semiconductor layer and an incident-side surface of the voltage application electrode onto which the light or radiation is incident and sealing the voltage application electrode;
an active matrix substrate for reading the converted electric charge information, the active matrix substrate being deposited at a side opposite to the incident side of the semiconductor layer; and
a conductor deposited on a first area which is located at an incident side of the insulating layer onto which the light or radiation is incident and faces the voltage application electrode,
wherein the conductor is connected to a ground.

According to the third aspect, the conductor is deposited on the first area which is located at the incident side of the insulating layer sealing the voltage application electrode and which faces the voltage application electrode. Further, the conductor is connected to the ground. Accordingly, static electricity generated in the area which is located at the incident side of the insulating layer and faces the voltage application electrode can be removed. Therefore, the influence of static electricity can be reduced. Moreover, it is needless to say that the conductor allows light or the radiation to be incident thereon.

According to a fourth aspect of the present invention, the light or radiation detector of the third aspect further comprises:
a driving section for driving the active matrix substrate;
an amplifying section for amplifying the electric charge information read by the active matrix substrate; and
wiring lines for connecting the active matrix substrate and the driving section and for connecting the active matrix substrate and the amplifying section,
wherein the conductor is deposited on a second area which includes at least an area facing the active matrix substrate and the wiring lines excluding the first area.

According to the fourth aspect, the conductor also is deposited on the second area which includes at least the area facing the active matrix substrate and the wiring lines excluding the first area. Accordingly, the influence of static electricity on the active matrix substrate for reading the electric charge information, the wiring lines for connecting the active matrix substrate and the driving section, and the wiring lines for connecting the active matrix substrate and the amplifying section can be reduced. Therefore, the noise component can be prevented from overlapping the electric charge information generated by the radiation. Moreover, the second area may include the entire incident-side surface of the insulating layer, excluding the first area.

According to a fifth aspect of the present invention, in the light or radiation detector of the third or fourth aspect, the semiconductor layer is a radiation-sensitive semiconductor layer for directly converting the radiation information into the electric charge information.

In a case of the direct conversion type semiconductor layer in which an electric charge is directly generated from the radiation, an application voltage increases, and thus the influence of static electricity becomes large. Therefore, according to the fifth aspect, it has great advantage that the influence of static electricity can be reduced, and thus the noise component can be drastically reduced.

According to a sixth aspect of the present invention, in the light or radiation detector of any one of the third to fifth aspects, the conductor is made of a material mainly containing a resin and having electrical conductivity.

According to the sixth aspect, the conductor mainly containing the resin has a low radiation shielding rate as compared to a metal material and thus it almost transmits the incident radiation. Therefore, even though the conductor is arranged on the first area, the electric charge information converted from the radiation is prevented from being weakened. Further, the conductor mainly containing the resin has a low specific resistance as compared to the metal material, and thus static electricity is slowly removed. As a result, the influence caused by a change in static electricity can be reduced. In addition, electric lines of force between the voltage application electrode and the conductor are not concentrated as compared to the metal material, and thus a pass-through discharge is prevented from being caused.

According to a seventh aspect of the present invention, in the light or radiation detector of the sixth aspect, the conductor is made of a material having elasticity.

According to the seventh aspect, since the conductor has elasticity, the semiconductor layer can be protected from vibration and impact.

According to a eighth aspect of the present invention, in the light or radiation detector of the fourth or fifth aspect, the conductor is divided into a first conductor and a second conductor, the first conductor being deposited on the first area and the second conductor being deposited on the second area, and the second conductor has a lower specific resistance than the first conductor.

Since the first area is the area which is located at the incident side of the insulating layer and which faces the voltage application electrode, static electricity is most easily generated. On the other hand, the second area has little static electricity as compared to the first area. However, since the second area partially faces the active matrix substrate or the wiring lines, it is preferable that the influence of static electricity on the second area be reduced, similarly to the first area. According to the eighth aspect, since the material having the relatively high specific resistance is deposited on the first area, static electricity can be slowly removed and thus the influence caused by the change in static electricity can be reduced. On the other hand, since the material having the relatively low specific resistance is deposited on the second area, static electricity can be rapidly removed. Moreover, at this time, the generated static electricity is weak, the change in static electricity is small, and thus the influence caused by the change in static electricity is small.

According to a ninth aspect of the present invention, there is provided a light or radiation detector for detecting light or a radiation, comprising:
a semiconductor layer for converting light information or radiation information into electric charge information for light or the radiation incident thereon;
a voltage application electrode for applying a voltage to the semiconductor layer, the voltage application electrode being deposited at an incident side of the semiconductor layer onto which the light or radiation is incident;
an insulating layer for covering the semiconductor layer and an incident-side surface of the voltage application electrode onto which the light or radiation is incident and sealing the voltage application electrode;
an active matrix substrate for reading the converted electric charge information, the active matrix substrate being deposited at a side opposite to the incident side of the semiconductor layer;
a conductor deposited on a first area which is located at an incident side of the insulating layer onto which the light or radiation is incident and faces the voltage application electrode; and
a case for housing the semiconductor layer, the voltage application electrode, the insulating layer, the active matrix substrate, and the conductor,
wherein the conductor is electrically connected to the case.

According to the ninth aspect, the conductor is deposited on the first area which is located at the incident side of the insulating layer sealing the voltage application electrode and faces the voltage application electrode. Further, the conductor is electrically connected to the case. As a result, the conductor and the insulating layer can have the same electric potential. Therefore, the influence of static electricity can be reduced such that static electricity is not discharged to the case.

### BRIEF DESCRIPTION OF THE DRAWINGS

FIG. 1 is a schematic cross-sectional view of a radiation detector according to a first embodiment of the present invention.

FIG. 2 is a plan view showing a configuration of the radiation detector according to the first embodiment of the present invention.

FIG. 3 is a schematic cross-sectional view of a radiation detector according to a modification of the present invention.

FIG. 4 is a schematic cross-sectional view of a two-dimensional radiation detector according to a second embodiment of the present invention.

FIG. 5 is a plan view showing a schematic configuration of an active matrix substrate, a gate driver, and an amplifier.

FIG. 6 is a schematic cross-sectional view of a two-dimensional radiation detector according to a third embodiment of the present invention.

FIG. 7 is a schematic cross-sectional view of a related-art radiation detector.

FIG. 8 is a schematic cross-sectional view of a related-art two-dimensional radiation detector.

### DETAILED DESCRIPTION OF THE INVENTION

Exemplary, non-limiting embodiments of the present invention will now be described with reference to the accompanying drawings.

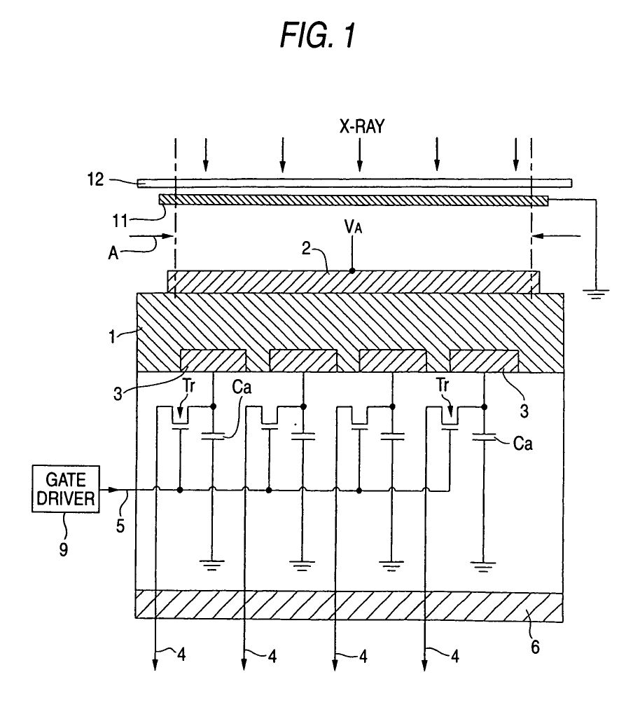

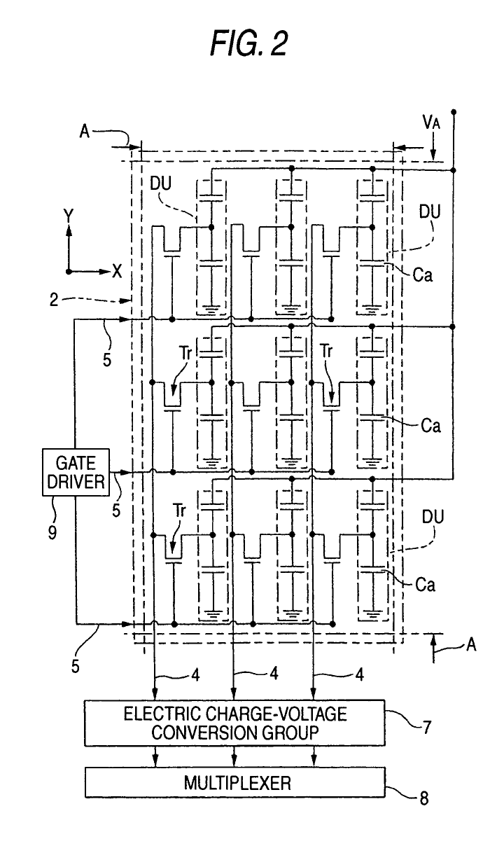

FIG. 1 is a schematic cross-sectional view of a radiation detector according to a first embodiment of the present invention and FIG. 2 is a plan view showing a configuration of the radiation detector according to the first embodiment of the present invention. In the first embodiment, a direct conversion type radiation detector is exemplified.

As shown in FIG. 1, the radiation detector according to the first embodiment has a radiation-sensitive semiconductor thick film 1, a voltage application electrode 2, carrier collection electrodes 3, electric charge storing capacitors Ca and thin film transistors (TFTs) Tr. On the radiation-sensitive semiconductor thick film 1, a radiation such as an X-ray is incident so that carriers are produced. The voltage application electrode 2 is provided on a surface of the semiconductor thick film 1. The carrier collection electrodes 3 is provided on a rear surface opposite to the side of the semiconductor thick film 1 on which the radiation is incident. The electric charge storing capacitors Ca stores the carriers collected by the carrier collection electrodes 3. The thin film transistors (TFTs) Tr serves as electric charge deriving switching elements, which are usually turned off (cut-off), for deriving electric charges stored in the capacitors Ca. The semiconductor thick film 1 corresponds to a semiconductor layer in the present invention.

In addition, the radiation detector further has data lines 4 each connected to a source of the thin film transistor Tr and gate lines 5 each connected to a gate of the thin film transistor Tr. The voltage application electrode 2, the semiconductor thick film 1, the carrier collection electrodes 3, the capacitors Ca, the thin film transistors Tr, the data lines 4, and the gate lines 5 are deposited on an insulating substrate 6.

As shown in FIGS. 1 and 2, the above-mentioned capacitors Ca and the thin film transistors Tr are connected to a plurality of carrier collection electrodes 3 (1024×1024) which are arranged in a two-dimensional matrix shape, respectively. Here, the carrier collection electrode 3, the capacitor Ca, and the thin film transistor Tr forms a detection element DU. Further, the voltage application electrode 2 is formed over the entire surface of the semiconductor thick film 1 and serves as a common electrode of all the detection elements DU. Further, as shown in FIG. 2, the plurality of data lines 4 are arranged parallel to each other in a vertical (Y) direction, and, as shown in FIG. 2, the plurality of gate lines 5 are arranged parallel to each other in a horizontal (X) direction. Each data line 4 and each gate line 5 are connected to each detection element DU. Further, the data lines 4 are connected to a multiplexer 8 through an electric charge-voltage conversion group 7, and the gate lines 5 are connected to a gate driver 9. In addition, the number of the arranged detection elements DU is not limited to 1024×1024, but may be changed corresponding to other embodiments. Therefore, the detection elements DU may be only one type. Furthermore, an amplifier (not shown) is provided in the electric charge-voltage conversion group 7.

When constituting a radiation detector provided with the semiconductor thick film 1, the insulating substrate 6, and so on, the data lines 4 and the gate lines 5 are provided on the surface of the insulating substrate 6 by using thin film formation technologies such as vacuum deposition methods or patterning technologies such as photolithography methods. Then, the thin film transistors Tr, the capacitors Ca, the carrier collection electrodes 3, the semiconductor thick film 1, the voltage application electrode 2, and so on are sequentially deposited thereon. A semiconductor for forming the semiconductor thick film 1 may be suitably selected among an amorphous semiconductor, a crystalline semiconductor, and so on according to purposes or dielectric strength. In addition, a material for forming the semiconductor thick film 1 is not specifically limited to selenium (Se) or the like. Since the first embodiment adopts the direct conversion type radiation detector, the semiconductor thick film 1 is made of amorphous selenium.

The radiation detector provided with the semiconductor thick film 1, the insulating substrate 6, and so on is housed in a case (not shown) and a shielding plate 11 is arranged on the case. A photo timer 12 for measuring an amount of a radiation is arranged at the side of the shielding plate 11 on which the radiation is incident. Further, the shielding plate 11 is arranged over an entire surface of an effective area A for X-ray detection shown in FIGS. 1 and 2. The size of the effective area A for X-ray detection is almost the same as that of the voltage application electrode 2. In addition, the shielding plate 11 and the photo timer 12 are apart from each other such that the shielding plate 11 and the photo timer 12 are electrically isolated from each other. In this case, when the shielding plate 11 physically comes into contact with the photo timer 12, an insulating material or the like is interposed between the shielding plate 11 and the photo timer 12. Moreover, when the shielding plate 11 and the photo timer 12 are excessively apart from each other, the measured radiation amount from the photo timer 12 is not accurately reflected. Therefore, it is preferable that the shielding plate 11 and the photo timer 12 be arranged so as to be adjacent to each other. The shielding plate 11 corresponds to a shielding member in the present invention, and the photo timer 12 corresponds to a radiation amount measuring member in the present invention. In addition, the effective area A for X-ray detection corresponds to an effective area for radiation detection in the present invention.

The shielding plate 11 is made of a material, such as conductive carbon or a thin plate of aluminum (Al), whose radiation shielding rate is low. Moreover, since nickel (Ni) or copper (Cu) has a high radiation shielding rate, it can be expected that the incident radiation, in addition to the noise, be shielded. Thus, it is preferable that the shielding plate 11 be made of conductive carbon or the aluminum plate. Conductive carbon is carbon which has higher electric conductivity than common carbon and to which a conductive filler (additive) is added. In addition, the shielding plate 11 may use the aluminum plate or an aluminum tape having a thickness of 0.3 μm or several hundreds of μm.

As shown in FIG. 1, the shielding plate 11 is connected to a ground. As a method of connecting the shielding plate 11 to the ground, for example, the shielding plate is connected to the conductive case. When considering that a radiation noise described below is released by connecting the shielding plate 11 to the ground, it is preferable that the shielding plate 11 may be made of a material having high electric conductivity. More preferably, the shielding plate 11 may be made of conductive carbon rather than common carbon or the aluminum plate.

Next, the operation of the radiation detector according to the first embodiment will be described. A radiation to be detected is incident onto the radiation detector in a state in which a high bias voltage VA (for example, several hundreds of volts to several tens of hundreds of volts) is applied to the voltage application electrode 2.

The incident radiation transmits the photo timer 12 and the shielding plate 11. The photo timer 12 measures the amount of the incident radiation and sends the measured radiation amount to an X-ray generating system (not shown). Since the shielding plate 11 is made of a material having a low shielding rate, the radiation transmits the shielding plate 11 without attenuation and only light or a radiation other than the radiation to be detected is shielded by the shielding plate 11. Further, the noise is generated from a switching power supply or a driving circuit for driving the photo timer 12, or the wiring lines for connecting the driving circuit or the switching power supply to the photo timer, and the noise is spread as the radiation noise to the shielding plate 11 or the radiation detector housed in the case. However, according to the present invention, the shielding plate 11 is connected to the ground, and thus the radiation noise is released to the ground through the shielding plate 11.

The radiation is incident thereon so that the carriers are generated, and the carriers are stored as electric charge information in the electric charge storing capacitors Ca. The gate line 5 is selected by the scanning signal of the gate driver 9 for deriving signals and the detection element DU connected to the selected gate line 5 is selectively designated. The electric charges stored in the capacitor Ca of the designated detection element DU is read onto the data line 4 via the thin film transistor Tr which is turned on by the signal of the selected gate line 5.

In addition, an address designation of each detection element DU is performed based on the scanning signals of the data line 4 and the gate line 5 for driving signals. When the scanning signals for driving signals are input to the multiplexer 8 and the gate driver 9, each detection element DU is selected according to the scanning signal in the vertical (Y) direction from the gate driver 9 and the multiplexer 8 is switched according to the scanning signal of the horizontal (X) direction. Thus, the electric charges stored in the capacitor Ca of the selected detection element DU is sent outside sequentially passing through the electric charge-voltage conversion group 7 and the multiplexer 8 via the data line 4.

When, for example, the radiation detector according to the first embodiment is used for detection of a fluoroscopic X-ray image of an X-ray fluoroscopy device in such a manner, the electric charge information read outside through the data line 4 is converted into image information and the converted image information is output the fluoroscopic X-ray image.

According to the above-mentioned first embodiment, the shielding plate 11 is made of the conductive material connected to the ground (for example, conductive carbon or the aluminum plate) and the shielding plate 11 is arranged over the entire surface of the effective area A for X-ray detection between the photo timer 12 and the semiconductor thick film 1. Therefore, the shielding plate 11 shields the radiation noise from the photo timer 12, and thus the radiation noise can be released by connecting the shielding plate 11 to the ground. As a result, the radiation noise from the photo timer 12 which has influence on the radiation detector can be reduced.

Further, like the first embodiment, when the direct conversion type radiation detector is adopted, the semiconductor thick film is thick and the high bias voltage is applied as compared to the indirect conversion type radiation detector. In the related-art, under the same conditions, the radiation noise from the photo timer 12 is conspicuous. Therefore, the radiation detector according to the present invention is particularly useful for reducing the radiation noise.

The present invention is not limited to the above-mentioned first embodiment, but the following modifications may be made.

(1) According to the above-mentioned first embodiment, the present invention adopts the direct conversion type radiation detector in which the incident radiation is directly converted into the electric charge information by the semiconductor thick film 1 (the semiconductor layer). However, according to the present invention, the indirect conversion type radiation detector in which the incident radiation is converted into light by a scintillator and sequentially light is converted into the electric charge information by the semiconductor layer made of a light-sensitive material may be adopted.

(2) According to the above-mentioned first embodiment, the X-ray detection device is exemplified. However, according to the present invention, a detection device for detecting a y-ray which is used for a nuclear medical device may be adopted.

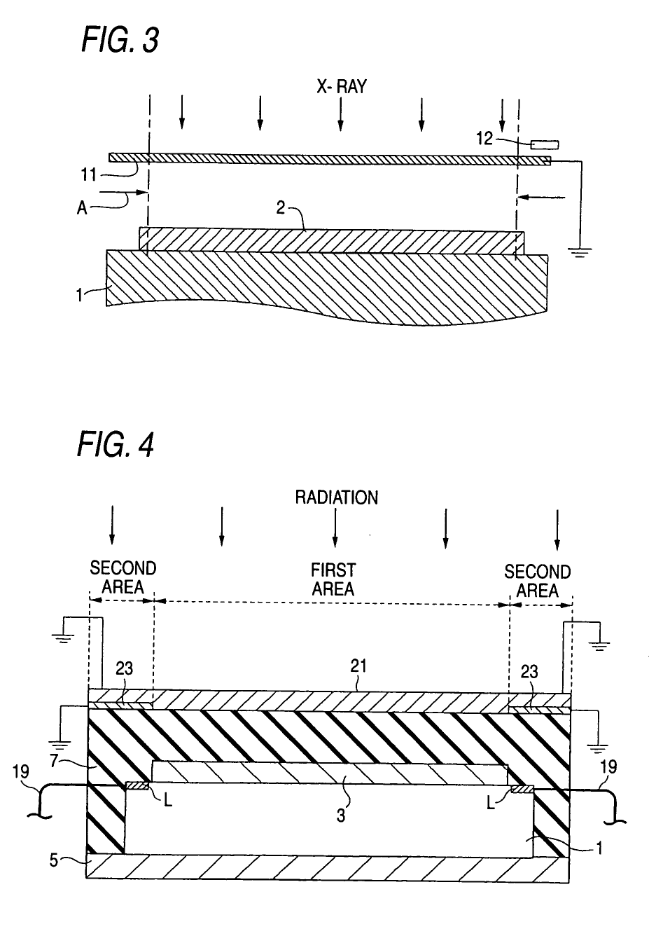

(3) According to the above-mentioned first embodiment, the photo timer 12 (the radiation amount measuring member) is arranged over the entire surface of the effective area A for X-ray detection (the effective are for radiation detection) together with the shielding plate 11. However, the photo timer 12 may be arranged, for example, at a corner other than the effective area A, as shown in FIG. 3. In this case, since the radiation noise from the photo timer 12 may have influence on the detection device through the voltage application electrode 2, the shielding plate 11 may also be arranged over the entire surface of the effective area A for X-ray detection, regardless of the arrangement location or the size of the photo timer 12.

Next, a second embodiment of the present invention will now be described with reference to the accompanying drawings.

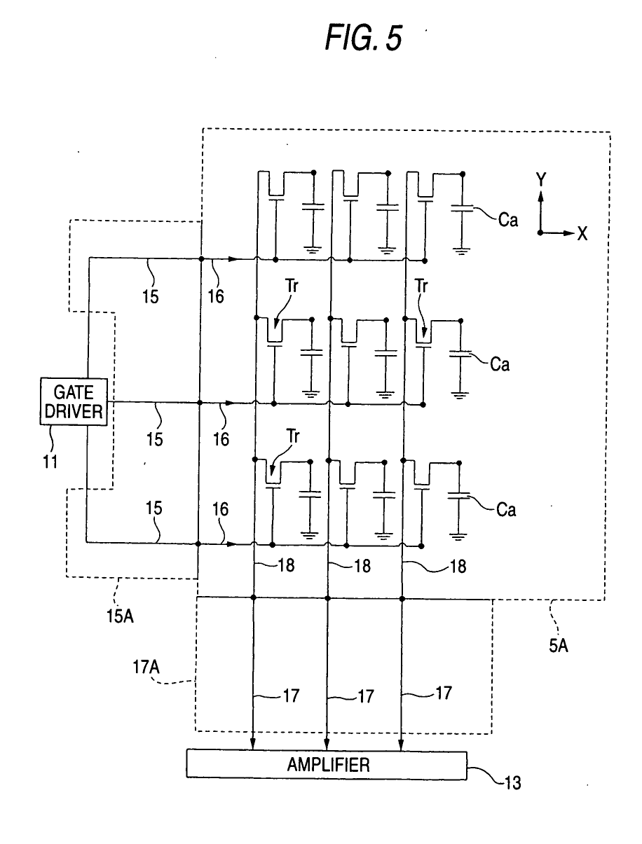

FIG. 4 is a schematic cross-sectional view of a two-dimensional radiation detector according to a second embodiment of the present invention. FIG. 5 is a plan view showing a schematic configuration of an active matrix substrate, a gate driver, and an amplifier.

The two-dimensional radiation detector according to the second embodiment detects a radiation incident in a direction indicated by a solid arrow in FIG. 4. The radiation is an X-ray, for example. The two-dimensional radiation detector has a radiation-sensitive semiconductor thick film 1, a voltage application electrode 3, and an active matrix substrate 5. The radiation-sensitive semiconductor thick film 1 converts radiation information into electric charge information. The voltage application electrode 3 is deposited at a side of the semiconductor thick film 1 on which the radiation is incident (hereinafter, simply referred to as ‘an incident side’). The active matrix substrate 5 is provided on a rear surface opposite to the incident side of the semiconductor thick film 1 and collects and reads the electric charge information. Further, the two-dimensional radiation detector comprises an insulating film 7, and two kinds of conductive plates 21 and 23. The insulating film 7 is formed to cover an incident-side surface of the voltage application electrode 3 together with the semiconductor thick film 1 and seals the voltage application electrode 3. The two kinds of conductive plates 21 and 23 are deposited on the incident side of the insulating film 7 and are connected to a ground. The semiconductor thick film 1, the voltage application electrode 3, and the insulating film 7 correspond to a semiconductor layer, a voltage application electrode and an insulating layer of the present invention, respectively. In addition, the conductive plates 21 and 23 together correspond to a conductor of the present invention.

In addition, as shown in FIG. 5, the two-dimensional radiation detector comprises a gate driver 11 for driving the active matrix substrate 5, an amplifier 13 for amplifying the electric charge information read by the active matrix substrate 5, gate wiring lines 15 for connecting the gate driver 11 to the active matrix substrate 5, and data wiring lines 17 for connecting the amplifier 13 to the active matrix substrate 5. The gate driver 11 corresponds to a driving section of the present invention and the amplifier 13 corresponds to an amplifying section of the present invention.

The active matrix substrate 5 has capacitors Ca for storing the electric charge information, thin film transistors (TFTs) Tr serving as switching elements for deriving the electric charge information, gate lines 16 each connected to a gate of the thin film transistor Tr, and data lines 18 each connected to a source of the thin film transistor Tr. The capacitor Ca is connected to a carrier collection electrode (not shown). With the capacitor Ca and the thin film transistor Tr in a pair, a plurality of pairs (1024×1024) are separately provided on the active matrix substrate 5 in a two-dimensional matrix shape. In addition, the gate lines 16 are arranged parallel to each other in a horizontal (X) direction and the data lines 18 are arranged parallel to each other in a vertical (Y) direction. The other ends of the gate lines 16 and the data lines 18 pass through through-holes (not shown) formed in a peripheral portion of the semiconductor thick film 1 and are erected toward the incident side of the semiconductor thick film 1. The portions to which the other ends of the gate lines 16 and the data lines 18 are erected are designated by a reference numeral L in FIG. 4. The active matrix substrate 5 corresponds to an active matrix substrate of the present invention.

The gate lines 16 and the data lines 18 erected are electrically connected to the gate wiring lines 15 and the data wiring lines 17 respectively. As shown in FIG. 4, the gate wiring lines 15 or the data wiring lines 17 are formed on a flexible substrate 19. Therefore, while the gate lines 16 or the data lines 18 are provided on the active matrix substrate 5, the gate wiring lines 15 or the data wiring lines 17 are provided on the flexible substrate 19. However, the gate lines 16 and the gate wiring lines 15 or the data lines 18 and the data wiring lines 17 transmit the same signal. The gate wiring lines 15 and the data wiring lines 17 together correspond to wiring lines of the present invention.

As described above, the other ends of the gate wiring lines 15 and the data wiring lines 17 are respectively connected to the gate driver 11 and the amplifier 13. Moreover, though not shown in FIG. 4, the gate driver 11 or the amplifier 13 is also mounted on the flexible substrate 19.

In the second embodiment, as shown in FIG. 5, the gate driver 11 is arranged at one side in the X direction of the active matrix substrate 5 and the amplifier 13 is arranged at one side in the Y direction of the active matrix substrate 5. However, a plurality of gate drivers 11 may be arranged at both sides in the X direction of the active matrix substrate 5. Further, a plurality of amplifiers 13 may be arranged at both sides in the Y direction of the active matrix substrate 5. In this case, the gate wiring lines 15 or the data wiring lines 17 may be arranged around the active matrix substrate 5 according to the arrangement of the gate driver 11 or the amplifier 13.

When constituting the two-dimensional radiation detector provided with the semiconductor thick film 1, the active matrix substrate 5, and so on, the gate lines 16 and the data lines 18 are provided on the surface of the active matrix substrate 5 by using thin film formation technologies such as vacuum deposition methods or patterning technologies such as photolithography methods. Then, the thin film transistors Tr, the capacitors Ca, the semiconductor thick film 1, the voltage application electrode 3, the insulating film 7, and so on are sequentially deposited thereon.

A semiconductor for forming the semiconductor thick film 1 may be suitably selected among an amorphous semiconductor, a crystalline semiconductor, and so on according to purposes or dielectric strength. In addition, a material for forming the semiconductor thick film 1 is not specifically limited to selenium (Se) or the like. Since the second embodiment adopts the direct conversion type two-dimensional radiation detector, the semiconductor thick film 1 is made of amorphous selenium. On the other hand, as the active matrix substrate 5, glass or the like having an electrical insulating property is exemplified. As the insulating film 7, an inert mold resin mainly containing an insulating resin or an inert gas is exemplified.

In addition, the conductive plates 21 and 23 are deposited on the incident-side surface of the insulating film 7. As shown in FIG. 4, an area facing the voltage application-electrode 3 on the incident-side surface of the insulating film 7 is referred to as a first area. In addition, an area including the area facing the active matrix substrate 5, the gate wiring lines 15, and the data wiring lines 17, excluding the first area, is referred to as a second area.

The first area is almost the same area as that where static electricity is most easily generated and the incident radiation can be converted into the electric charge information by the semiconductor thick film 1. On the other hand, referring to FIG. 5, as for the second area, the range of the active matrix substrate 5 is designated by reference numeral 5A, the range of the gate wiring lines 15 is designated by reference numeral 15A, and the range of the data wiring lines 17 is designated by reference numeral 17A. In addition, the second area is the area covering all these ranges. From this, it is understood that the second area is preferably protected from the influence of static electricity, similarly to the first area. Referring to FIG. 4, the flexible substrate 19 extends to end surfaces of the insulating film 7, and thus the second area also extends to edges of the insulating film 7.

In addition, the conductive plates 21 and 23 are divided into the first conductive plate 23 deposited on the first area and the second area and the second conductive plate 23 deposited on only the second area. As shown in FIG. 4, on the second area, the insulating film 7, the second conductive plate 23 and the first conductive plate 21 are sequentially deposited.

The first conductive plate 21 and the second conductive plate 23 together are connected to the ground. For example, the first conductive plate 21 and the second conductive plate 23 may be directly connected to the ground electrode. When the case (not shown) is connected to the ground, the first conductive plate 21 and the second conductive plate 23 may be electrically connected to the case, thereby to use the ground electrode common to the case.

The first conductive plate 21 is made of a material having high specific resistance and low electrical conductivity. Therefore, the charged static electricity can be slowly removed. Specifically, it is preferable that the surface resistance value be in a range of from 10⁵ Ω to 10⁸ Ω. When the surface resistance value is 10⁵ Ω or less, the movement speed of static electricity is fast. Since the first area is the range that the static electricity is most easily charged, the movement amount of static electricity may be large and the change in static electricity may be rapid. On the other hand, if the surface resistance value is 10⁸ Ω or more, the static electricity cannot be completely removed, even when the static electricity is charged. Thus, it is expected that the conductive plate be in the normally charged state and thus the electric potential rather increases. Specifically, the same phenomenon as that when static electricity is charged on the surface of the insulating film 7 occurs, so that the influence of static electricity cannot be reduced. To the contrary, when the surface resistance value is in a range of from 10⁵ Ω to 10⁸ Ω, the movement speed of static electricity is suitably reduced, so that static electricity can be removed. As a result, the change in static electricity can be decreased and the noise component can be prevented from occurring.

In addition, since the first conductive plate 21 is made of a material having high specific resistance and low electrical conductivity, when the voltage is applied to the voltage application electrode 3, the electric lines of force are prevented from concentrating between the voltage application electrode 3 and the first conductive plate 21. As a result, the pass-through discharge can be prevented from being caused.

According to the second embodiment, the first conductive plate 21 is made of the conductive material mainly containing the resin and having the surface resistance value ranging from 10⁵ Ω to 10⁸ Ω. The material mainly containing the resin is suitably used for the material of the conductive plate 21 because it has a lower radiation shielding rate than a metal material such as aluminum and the semiconductor thick film 1 can accurately convert the radiation into the electric charge information.

Further, according to the second embodiment, the first conductive plate 21 is made of a material having elasticity. Therefore, the semiconductor thick film 1 or the like can be protected from vibration and impact. As such a material, conductive polyethylene foams or the like, in which foams are formed by conductive fillers such as a metal material or a carbon material are remolded in the resin, is exemplified. When the foams such as the conductive polyethylene foams are used, the incident radiation is almost not shielded.

Also, the second conductive plate 23 is made of the conductive material. As described above, on the second area, the influence of static electricity should be reduced, similarly to the first area. According to the second embodiment, the second conductive plate 23 is made of a metal material having low specific resistance and high electrical conductivity in general. Therefore, the static electricity can be immediately removed. Moreover, at this time, since the generated static electricity is weak, the change in static electricity is small. In the second area, since the X-ray is not incident thereon, it is not required to consider the attenuation, and an aluminum plate or a copper plate is preferably used as the metal material. Further, when the metal material is a metal thin film or a metal tape made of aluminum or copper having a thickness of several hundreds of μm, it is easy to work.

Subsequently, the operation of the second embodiment will be described. The radiation is incident on the two-dimensional radiation detector in a state in which the voltage is applied to the voltage application electrode 3.

By applying the voltage to the voltage application electrode 3, static electricity is charged on the incident-side surface of the insulating film 7 around the first area. The charged static electricity moves into the first conductive plate 21 connected to the ground. At this time, since the first conductive plate 21 has high surface resistance, static electricity slowly moves into the first conductive plate 21. In addition, static electricity is relieved to the ground electrode to which the first conductive plate 21 is connected. Therefore, static electricity generated on the first area can be slowly removed.

In addition, the static electricity charged on the second area moves into the second conductive plate 23. Since the second conductive plate 23 is made of the metal material which is a favorable conductor, static electricity immediately moves into the second conductive plate 23 and is released into the ground electrode. Therefore, static electricity generated on the second area can be rapidly removed.

On the other hand, the radiation transmits the first conductive plate 21 and the second conductive plate 23. Since the first conductive plate 21 is made of the conductive material mainly containing the resin, the first conductive plate 21 allows the radiation to be transmitted without attenuation. To the contrary, since the second conductive plate 23 is made of the metal material, the second conductive plate 23 attenuates the radiation somewhat. The radiation reaching to the semiconductor thick film 1 mainly transmits only the first conductive plate 21. Therefore, the attenuation of the radiation by means of the second conductive plate 23 almost does not have influence on the converted electric charge information.

The incident radiation is converted into the electric charge information by the semiconductor thick film 1. The converted electric charge information is read by the active matrix substrate 5. Specifically, first, the capacitor Ca stores the converted electric charge information. The gate driver 11 sequentially selects the gate wiring lines 15 to transmit the scanning signal. The scanning signal is input to the gate of the thin film transistor Tr through the gate line 16 as it is. As a result, the thin film transistor Tr is turned on, the electric charge information stored in the capacitor Ca is read by the data line 18 via the thin film transistor Tr. The read electric charge information is received by the amplifier 13 as it is via the data wiring line 17. After converting the electric charge information into voltage information, the amplifier 13 performs a series of workings such as the amplification of the voltage and the conversion of the amplified voltage into a digital signal. In addition, the digital signal is transmitted to the outside as a radiation detection signal.

For example, when the two-dimensional radiation detector according to the second embodiment is used for detecting a fluoroscopic X-ray image of an X-ray fluoroscopy device in such a manner, the radiation detection signal delivered to the outside via the amplifier 13 or the like is used for generating the fluoroscopic X-ray image as image information.

According to the above-mentioned two-dimensional radiation detector, the first conductive plate 21 is deposited on the first area which is located at the incident side of the insulating film 7 sealing the application electrode 3 and faces the application electrode 3. Further, the first conductive plate 21 is connected to the ground. As a result, static electricity generated at the incident side of the insulating film 7 can be removed. Therefore, static electricity can be prevented from being discharged, and thus the influence of static electricity can be reduced.

Further, since the first conductive plate 21 is made of a material having high specific resistance and low electrical conductivity, static electricity generated on the first area can be slowly removed.

Furthermore, the second conductive plate 23 which is made of a metal material having low specific resistance and high electrical conductivity is deposited on the second area which includes the area facing the active matrix substrate 5, the gate wiring line 15 and the data wiring line 17 excluding the first area. Therefore, static electricity can be rapidly removed.

Accordingly, the influence of static electricity generated on the incident-side surface of the insulating film 7 can be reduced. In addition, since the static electricity generated on the first area is smoothly removed, the influence caused by the change in static electricity can be reduced.

Further, like the second embodiment, the two-dimensional radiation detector is a direct conversion type two-dimensional radiation detector and the semiconductor thick film 1 is made of amorphous selenium. In this case, since the film thickness of the semiconductor thick film 1 is relatively thick, the application voltage is needed to be increased. Thus, the present invention is particularly useful for reducing the influence of static electricity.

The present invention is not limited to the above-mentioned second embodiment, but the following modifications may be made.

(1) According to the second embodiment, the first conductive plate 21 and the second conductive plate 23 use different materials from each other. However, the first and second conductive plates 21 and 23 may be made of a common conductive material without making the first conductive plate 21 and the second conductive plate 23 different from each other. For example, only the material which is exemplified as the material for the first conductive plate 21 may be arranged on the first and second areas. In this way, the configuration can be simplified. In addition, a configuration that the conductive plates are formed by depositing various conductive materials may be implemented as in the second area according to the second embodiment. In addition, a configuration that the conductive plate is deposited on only the first area may be implemented.

(2) According to the second embodiment, a configuration that a resistor or the like is interposed between the first conductive plate 21 and the ground electrode or the second conductive plate 23 and the ground electrode is not mentioned. However, the resister may be suitably interposed therebetween. Specifically, since static electricity can be slowly removed with a current limiting means such as a resistor, the same effects can be obtained even when the material for the first conductive plate 21 is not a material which has high specific resistance and low electrical conductivity.

(3) According to the second embodiment, the first and second conductive plates 21 and 23 are connected to the ground, but the present invention is not limited to such a configuration. Specifically, when the components arranged near the insulating film 7, that is, the case for housing the two-dimensional radiation detector and the respective conductive plates 21 and 23 have the same electric potential, the generated static electricity can be prevented from being discharged. Therefore, although the conductive plates 21 and 23 are not connected to the ground, since the conductive plates 21 and 23 are electrically connected to the case or the like, static electricity generated on the first area is prevented from being discharged.

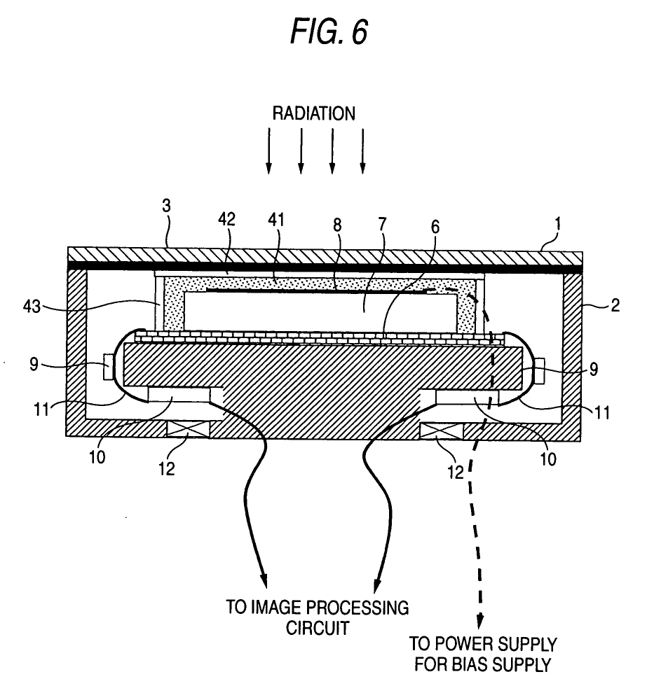

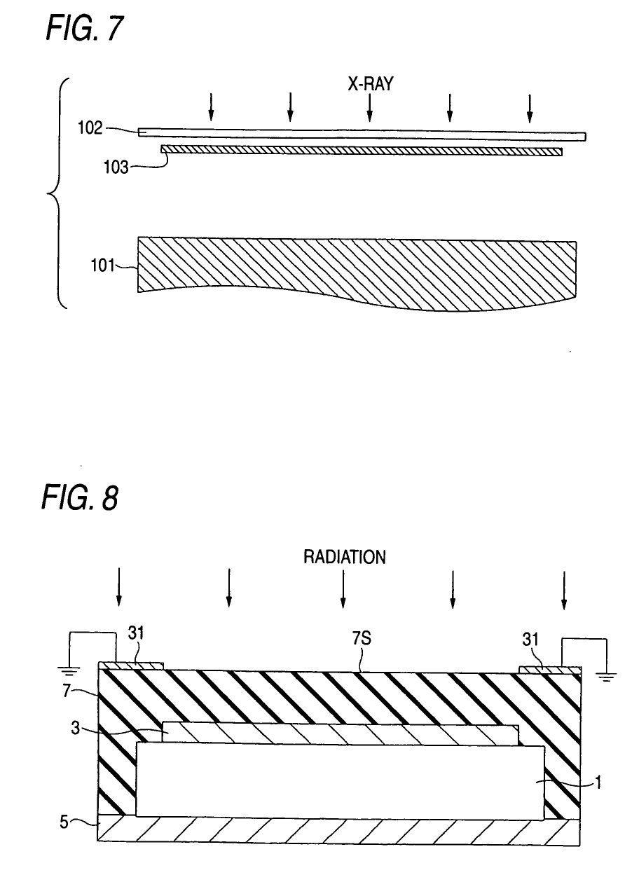

For example, FIG. 6 shows a two-dimensional radiation detector according to a third embodiment of the present invention. The two-dimensional radiation detector of the third embodiment comprises a radiation-sensitive semiconductor 7, a voltage application electrode 8, an insulating material 41, an insulating plate material 42, an insulating weir material 43, an active matrix substrate 6, a conductive material 3, and a case 1, 2. The case includes a non-conductive portion 1 and a conductive portion 2, and houses the semiconductor 7, the voltage application electrode 8, the insulating material 41, the insulating plate material 42, the insulating weir material 43, the active matrix substrate 6, and the conductive material 3. In this embodiment, the conductive material 3 is deposited on the first area which is located at the incident side of the insulating material 41 sealing the voltage application electrode 8 and faces the voltage application electrode 8. Further, the conductive material 3 is electrically connected to the conductive portion 2 of case. As a result, the conductive material 3 and the insulating material 41 can have the same electric potential. Therefore, the influence of static electricity can be reduced such that static electricity is not discharged to the case. In FIG. 6, the reference number 9 indicates LSI chip, 10 indicates a signal processing circuit, 11 indicates a flexible wiring film, and 12 indicates a cooling fan.

(4) According to the above-mentioned embodiment, the two-dimensional radiation detector is the direct conversion type two-dimensional radiation detector that the incident radiation is directly converted into the electric charge information by the semiconductor thick film 1. However, the two-dimensional radiation detector may be the indirect conversion type two-dimensional radiation detector that the incident radiation is converted into light by a scintillator and then light is converted into the electric charge information by the semiconductor layer made of the light-sensitive material. In addition, the present invention may be applied to a two-dimensional light detector for simply detecting light incident thereon.

1. A radiation detector for detecting a radiation, comprising:
a semiconductor layer for converting radiation information into electric charge information for a radiation incident thereon;
a radiation amount measuring member for measuring an amount of the radiation, the radiation amount measuring member being arranged at a side onto which the radiation is incident; and
a shielding member for shielding light, the shielding member being arranged over an entire surface of an effective area for radiation detection between the radiation amount measuring member and the semiconductor layer,
wherein the shielding member is made of a conductive material connected to a ground.

2. The radiation detector according to claim 1,
wherein the semiconductor layer is a radiation-sensitive semiconductor layer for directly converting the radiation information into the electric charge information, and
the radiation detector is a direct conversion type radiation detector having the radiation-sensitive semiconductor layer.

3. A light or radiation detector for detecting light or a radiation, comprising:
a semiconductor layer for converting light information or radiation information into electric charge information for light or the radiation incident thereon;
a voltage application electrode for applying a voltage to the semiconductor layer, the voltage application electrode being deposited at an incident side of the semiconductor layer onto which the light or radiation is incident;
an insulating layer for covering the semiconductor layer and an incident-side surface of the voltage application electrode onto which the light or radiation is incident and sealing the voltage application electrode;
an active matrix substrate for reading the converted electric charge information, the active matrix substrate being deposited at a side opposite to the incident side of the semiconductor layer; and
a conductor deposited on a first area which is located at an incident side of the insulating layer onto which the light or radiation is incident and faces the voltage application electrode,
wherein the conductor is connected to a ground.

4. The light or radiation detector according to claim 3, further comprising:
a driving section for driving the active matrix substrate;
an amplifying section for amplifying the electric charge information read by the active matrix substrate; and
wiring lines for connecting the active matrix substrate and the driving section and for connecting the active matrix substrate and the amplifying section,
wherein the conductor is deposited on a second area which includes at least an area facing the active matrix substrate and the wiring lines excluding the first area.

5. The light or radiation detector according to claim 3,
wherein the semiconductor layer is a radiation-sensitive semiconductor layer for directly converting the radiation information into the electric charge information.

6. The light or radiation detector according to claim 3,
wherein the conductor is made of a material mainly containing a resin and having electrical conductivity.

7. The light or radiation detector according to claim 6,
wherein the conductor is made of a material having elasticity.

8. The light or radiation detector according to claim 4,
wherein the conductor is divided into a first conductor and a second conductor, the first conductor being deposited on the first area and the second conductor being deposited on the second area, and
the second conductor has a lower specific resistance than the first conductor.

9. A light or radiation detector for detecting light or a radiation, comprising:
a semiconductor layer for converting light information or radiation information into electric charge information for light or the radiation incident thereon;
a voltage application electrode for applying a voltage to the semiconductor layer, the voltage application electrode being deposited at an incident side of the semiconductor layer onto which the light or radiation is incident;
an insulating layer for covering the semiconductor layer and an incident-side surface of the voltage application electrode onto which the light or radiation is incident and sealing the voltage application electrode;
an active matrix substrate for reading the converted electric charge information, the active matrix substrate being deposited at a side opposite to the incident side of the semiconductor layer;
a conductor deposited on a first area which is located at an incident side of the insulating layer onto which the light or radiation is incident and faces the voltage application electrode; and
a case for housing the semiconductor layer, the voltage application electrode, the insulating layer, the active matrix substrate, and the conductor,
wherein the conductor is electrically connected to the case.
